(19) United States
(12) Patent Application Publication
(10) Pub. No.: US 2012/0012135 A1
(43) Pub. Date: Jan. 19, 2012

(54) LAUNDRY MACHINE AND CONTROL METHOD THEREOF

(76) Inventors: Sang Wook Hong, Seoul (KR); Jae Won Chang, Seoul (KR); Sun Young Park, Seoul (KR); Bon Kwon Koo, Seoul (KR); Ki Young Kang, Seoul (KR); Ji Hee Kim, Seoul (KR)

(21) Appl. No.: 13/260,132

(22) PCT Filed: Sep. 11, 2009
(86) PCT No.: PCT/KR2009/005192

§ 371 Date: Sep. 23, 2011

(30) Foreign Application Priority Data
May 4, 2009 (AT) 10-2009-0039051

(51) Int. Cl. D06F 33/00; B08B 3/04

(52) U.S. Cl. 134/18; 68/12.12

(57) ABSTRACT

Disclosed are a laundry machine, which allows a user to easily change an operating time so as to enable convenient use, and a control method of the laundry machine. The control method includes receiving an operation, which is to be performed for treating laundry, input by a user, receiving a time, which is required to complete the operation from a start time or re-start time of the operation, input by the user, and performing the operation according to the input time.

### TECHNICAL FIELD

The present invention relates to a laundry machine and a control method thereof, and more particularly, to a laundry machine, which allows a user to easily change an operating time so as to enable convenient use, and a control method of the laundry machine.

### BACKGROUND ART

In general, laundry machines refer to apparatuses for washing and/or drying laundry. Such laundry machines include washing machines, drying machines, and washing/drying machines. Further, these laundry machines are divided into drum-type laundry machines, which treat laundry contained within a rotating drum, and cabinet-type laundry machines, which treat laundry contained in a fixed space.

The drum-type laundry machines are divided into a horizontal axis-type laundry machine and a vertical axis-type laundry machine according to the angle of a rotary axis of a rotating drum.

The horizontal axis-type laundry machine has a rotary axis of a drum, which is provided approximately horizontally, and raises and drops laundry according to the rotation of the drum so as to treat the laundry. Of course, a tilted laundry machine, in which a rotary axis of a drum is tilted at a designated angle, has been widely used. Here, the designated angle is in the range of approximately 5 to 15 degrees. The above structure of the horizontal axis-type laundry machine is applied to washing machines and washing/drying machines as well as drying machines. The horizontal axis-type laundry machine is generally referred to as a front loading laundry machine, because the laundry machine is provided with a door formed on the front surface of a cabinet, through which laundry is put into and taken out of the laundry machine. However, the term drum-type washing machine generally refers to a front loading laundry machine.

The vertical axis-type laundry machine has a rotary axis of a drum, which is provide substantially vertically, and the structure of the vertical axis-type laundry machine is applied to washing machines. These washing machines wash laundry using a current of water in the drum. The current of water may be formed by the rotation of the drum, or may be formed by the rotation of a pulsator in the drum. The vertical axis-type laundry machine is generally referred to as a top loading laundry machine, because the laundry machine is provided with a door formed on the top surface of a cabinet, through which laundry is put into and taken out of the laundry machine.

Recently, a laundry machine, which treats laundry using steam, has entered into widespread use.

In general, courses or cycles to treat laundry are set in a program in the laundry machine. For example, various washing courses are set in the laundry machine according to kinds of laundry and treating purposes of the laundry. Further, the washing courses are obtained by combining different kinds of cycles. For example, the washing courses are obtained by combining a washing cycle, a rinsing cycle, and a dehydrating cycle.

Factors required to perform these courses or cycles are set in advance. For example, operation times of the courses or cycles, or rotation patterns or rotation speeds of a drum in the courses or cycles are set. A user merely selects a desired course or cycle, and then pushes a start button. A controller controls the laundry machine such that the selected course or cycle is carried out according to the set factors of the selected course or cycle.

Further, the setting may be varied according to kinds of the courses or cycles. For example, the operation time of the washing cycle and the operation time of the rinsing cycle are generally set to be different values.

In the general laundry machine, if a user selects a specific course, or if a user selects a supplementary option in addition to the specific course, the operation of the laundry machine is started and completed by factors set in advance according to the selected course and option. Particularly, the operation of the laundry machine is performed for the operation time, which is set in advance according to the users selection.

Since factors, such as operation times of courses or cycles, are set in a program in the general laundry machine, the laundry machine has an advantage of convenient use. That is, the laundry machine can be automatically operated and then the operation can be completed only by simple manipulation of buttons, such as a course selection button and an operation start button.

However, the above setting has a drawback of difficulty in flexibly coping with various consumer's requirements or circumstances. For example, if a consumer wishes to change the setting of a specific course or cycle, the conventional laundry machine cannot satisfy this requirement. Particularly, the conventional laundry machine cannot change the setting of the operation time.

For example, in the case of a washing machine, on the assumption that an operation time of a certain washing course is set to be 1 hour 30 minutes, if a consumer wishes to use the washing course within 1 hour in order to go out, the consumer may not go out due to a time difference.

The conventional laundry machine allows consumers only to select the set factors, and thus cannot satisfy consumer's various requirements. Therefore, a laundry machine, which allows consumers to adjust set factors of courses or cycles so as to satisfy consumer's various requirements, is required.

### DISCLOSURE OF INVENTION

### Technical Problem

The present invention has been made in view of the above-mentioned problem, and an object of the present invention is to provide a laundry machine, which satisfies consumer's various requirements, and thus enables convenient use and has an improved utility, and a control method of the laundry machine.

A further object of the present invention is to provide a laundry machine, which allows a user to change not only operation times of a course operation but also operation times of respective cycles (for example, a washing cycle and a rinsing cycle) of the course, and a control method of the laundry machine.

Another object of the present invention is to provide a reliable laundry machine, which allows a user to change an operation time through simple manipulation and to visually confirm the change, and a control method of the laundry machine.

### Technical Solution

The objects of the present invention can be achieved by providing a control method of a laundry machine including receiving an operation, which is to be performed for treating laundry, input by a user, receiving a time, which is required to complete the operation from a start time or re-start time of the operation, input by the user, and performing the operation according to the input time.

Here, the operation may be a general course operation. That is, in the case of a washing machine, the operation may be an operation, which is performed by putting laundry into the washing machine and carrying out treatment of laundry through washing, rinsing, and dehydrating. The course operation is achieved by sequential combination of a plurality of cycles. For example, a washing course includes a washing cycle, a rinsing cycle, and a dehydrating cycle.

Further, the operation may include one cycle or a plurality of cycles. That is, in the case of the washing machine, the operation may be an operation performed by carrying out any one of the washing cycle, the rinsing cycle, and the dehydrating cycle, or may be an operation performed by carrying out a combination thereof, for example only the rinsing cycle and the dehydrating cycle.

The performance of the operation may include adjusting an operation time of the input operation, which is set in advance, if the set operation time of the input operation exceeds the input time. Although the contrary case is possible, most users wish to rapidly complete the operation, and thus the adjustment of the set operation time only if the set operation time exceeds the input time is simpler.

Here, the adjustment of the operation time is carried out on the assumption that a set operation time is present. If there is no set operation time, the operation may be performed according to the time input by the user. However, in order to satisfy user's various requirements, the set operation time may be required. Therefore, when the user directly inputs an operation time, the set operation time may not be worth consideration. In this case, the adjustment of the operation time may be changed to insertion of the operation time input by the user into an operating algorithm, which is set in advance.

Further, the control method may include selecting a manual operation. Here, the manual operation contrasts with an automatic operation, which is performed according to the set operation time, and means an operation, which is performed according to the operation time input by the user. That is, when the user selects the manual operation, the set operating time is ignored and the operation is performed according to the operation time input by the user. In this case, the above-described adjustment of the operation time may be excluded.

In the adjustment of the operation time, operation times of respective cycles forming the input operation, which are set in advance, may be adjusted.

The input of the time may be carried out when the operation starts to be performed, or may be carried out while the operation is in progress. The user may start the operation of the laundry machine by inputting factors relating to the operation to be performed through various input units of a control panel for interface with the user and then pushing an operation start button. Therefore, the input of the time may be carried out when the operation starts to be performed, for example, before the user pushes the operation start button. The input time may be a time taken to complete the operation from the start time of the operation.

Otherwise, the input of the time may be carried out while the operation is in progress. Of course, the input of the time at the moment a drum is driven is not preferable. Therefore, it is preferable that the input of the time be carried out after the operation is paused through a pause button (the pause button may be the same as the start button) while the operation is in progress. At this time, the input time may be a time taken to complete the operation from the re-start time of the operation.

The performance of the operation may be carried out such that the operation is completed within the input time. However, the time when the operation is substantially completed or the operation time may slightly differ from the input time. Such a difference is allowable due to an indispensable time factor required to perform the course operation or the cycle operation and an error. For example, a difference of several minutes may be allowed.

The control method may further includes receiving instructions, which change a controller to an operation performable state according to the input operation time, when the operation time is input, input by the user. The reception of the instructions may be the same as the above-described input of the manual operation. Therefore, the input of the manual operation may be carried out at any time before or after the user inputs the operation time.

The input of the manual operation may be included in the input of the operation time. In this case, the input units may be integrated into one unit.

In another aspect of the present invention, there is provided a laundry machine including a cabinet, a drum, in which laundry is contained, an operation selection unit provided for a user to select an operation, which is to be performed, and a controller. The laundry machine may further include a time input unit provided for the user to input an operation time, which is required to complete the operation from a start time or re-start time of the operation input through the operation selection unit. The user may select a desired course or cycle through the operation selection unit. Further, the controller may control the performance of the operation by driving the drum according to the input time.

Through the above control method, the user may adjust an operation time among factors, which are set in advance according to courses, to a desired value, while using other factors as they are.

For example, if a standard course, which is set in advance, is used, the user may adjust the operation time of the standard course to a desired value. Particularly, if the user is busy, the user may reduce the operation time of the standard course so as to enable convenient use.

In the standard course, kinds of cycles and operation times of the cycles are set in advance. These courses may be input by the user through a course dial among input units of a control panel. For example, in addition to the standard course, there may be a boil course, a silent course, an underwear course, a wool course, a bedclothes course, a speed wash course, a functional clothes course, an allergy care course, a steam wash course, etc. These courses are courses in washing machines, which are available on the market now, and indicate only one example. Various courses may be provided in the laundry machine according to kinds of target laundry to be treated or treating purposes of the laundry regardless of names of the courses, and the above adjustment may be applied to the courses.

Further, although kinds and operation times of cycles of the selected course operation are basically set, the user may slightly change the setting of the course through an option selection unit. For example, in the standard course including the washing cycle, the rinsing cycle, and the dehydrating cycle, a plurality of washing cycles rather than a single washing cycle may be provided, and the user may select one of the plurality of washing cycles and change the set washing cycle into the selected washing cycle. That is, when a washing cycle 1, a washing cycle 2, and a washing cycle 3 are provided and the washing cycle 1 is basically set in the standard course, the user may select the washing cycle 2 instead of the washing cycle 1 through the option selection unit. This selection looks like a change of the setting, but is only a change of selection among the setting and is no change of the setting. The user changes only selection among the setting, but does not change the setting itself and does not cause the controller to perform the course according to the changed setting.

When the user inputs an operation time after the selection of the course using the option selection unit or using only the course dial, the controller performs the course operation, as described above.

The input of the time may be carried out by inputting the total operation time of the course or respectively inputting operation times of all cycles forming the course. For example, let us suppose that the user wishes to adjust the total operation time of 1 hour 30 minutes set in the standard course, which is the sum of 1 hour for the operation time of the washing cycle, 20 minutes for the operation time of the rinsing cycle, and 10 minutes for the operation time of the dehydrating cycle, to 1 hour. Here, the user may input 1 hour for the total operation time, or may input 40 minutes for the operation time of the washing cycle, 13 minutes for the operation time of the rinsing cycle, and 7 minutes for the operation time of the dehydrating cycle.

Now, a case in which the total operation time of the course is input by the user during the input of the time will be described in more detail. In this case, the adjustment during the input of the time may be carried out for a specific cycle of the course, or may be carried out for all cycles of the course. For example, in the above standard course, the operation time of only the washing cycle may be adjusted to 30 minutes, and the operation times of the rinsing cycle and the dehydrating cycle may be maintained at 20 minutes and 10 minutes, respectively. Otherwise, the operation times of the washing cycle, the rinsing cycle, and the dehydrating cycle may be adjusted to 40 minutes, 13 minutes, and 7 minutes, respectively. Here, the specific cycle, for which the time adjustment is carried out, may be selected by the user. The control method may further include selecting the specific cycle by the user. That is, when the user selects the specific cycle, the adjustment of the operation time may be carried out only for the selected specific cycle of the selected course.

In case that the time adjustment is carried out for all cycles of the course, there are several adjusting methods. For example, the set operation times of the respective cycles are adjusted according to a time rate. In the above example, the respective adjustment of the operation times of the washing cycle, the rinsing cycle, and the dehydrating cycle to 40 minutes, 13 minutes, and 7 minutes denote adjustment of the operation times at the same time rate. That is, since the total operation time of the course is reduced from 1 hour 30 minutes to 1 hour by 33.3%, the operation times of the respective cycles of the course are respectively adjusted by 33.3%. The precise values of the adjusted operation times of the rinsing cycle and the dehydrating cycle are 13.333 minutes and 6.666 minutes, but the values are rounded off at the nearest decimal. The adjustment of the operation times according to the time rate substantially means an adjustment degree, but does not mean satisfaction in mathematical accuracy.

As described above, the adjustment of the operation time may be carried out for a selected specific cycle of the course. For example, a set operation time of the rinsing cycle may not be adjusted, but set operation times of the washing cycle and the dehydrating cycle may be adjusted. Although the course is performed for a reduced operation time, it is necessary to maintain the operation time of the rinsing cycle so as to prevent detergent from remaining on laundry.

Further, although the adjustment of the operation time is carried out for all cycles of the course, the time rate of the cycles may be varied. For example, the set operation time of the rinsing cycle may be adjusted to a value at a lower rate than those of other cycles.

Here, the selection of the specific cycle may be achieved by selecting the specific cycle or on the contrary by selecting other cycles except for the specific cycle. That is, in case that the operation time of the rinsing cycle is excluded from the adjustment of the operation time or is adjusted at a lower rate than those of other cycles, the user may select the rinsing cycle or select the washing cycle or the dehydrating cycle as a cycle, the operation time of which is relatively adjusted at a high rate. The reason why the difference of operation times between the specific cycle and other cycles is caused in the adjustment of the operation time is that although the total operation time of the course is adjusted, the user may have a preferred cycle, the operation time of which is not adjusted or is adjusted at a relatively low rate, among the washing cycle, the rinsing cycle, and the dehydrating cycle. For example, the user may wish to satisfactorily perform the washing cycle or the rinsing cycle even if the operation time of the course is reduced. The control method may further include receiving the specific cycle selected by the user. Further, an input unit to input the selection may be provided on the control panel.

If the user inputs the total operation time of the course and the adjustment of the operation time of the course thereby is carried out, the adjusted operation times of the respective cycles may be displayed.

Further, the user may re-adjust the adjusted operation times of the respective cycles. That is, when the operation times of the respective cycles of the course are displayed, the user may re-adjust the adjusted operation times.

The operation input during the input of the operation may be determined by respectively selecting a plurality of different kinds of cycles as well as by selecting a course by the user. That is, differing from the above description, a course, in which respective cycles are set in advance, may not be not selected by the user through the input unit, such as the course dial, but a course may be determined by selecting respective cycles by the user.

Although the determination of the course is carried out in the above manner, the input of the time and the performance of the course may be carried out in the same manner as the above description.

As describe above, the input of the time may be carried out while the operation is in progress. In this case, the performance of the operation is carried out such that the operation is completed within an input operation time while the operation is in progress. For example, when the user wishes to go out when the standard course is in progress, if 1 hour out of the total operation time remains, the user may adjust the remaining operation time to 30 minutes so as to rapidly complete the standard course.

In the operation of the course, the drum, which is rotated during dehydration before the rinsing cycle, may be continuously rotated at a reduced speed at least until drainage of the rinsing cycle

In general, when the washing cycle is completed, intermediate dehydration is carried out to discharge a large amount of moisture from laundry, and then the rinsing cycle is performed. Water is supplied to the drum under the condition that the drum is stopped, and then the rinsing cycle is performed by rotating the drum. When the drum is stopped and then is rotated again so as to perform the rinsing cycle, laundry may not be uniformly distributed in the drum, and thus a process of uniformly distributing the laundry in the drum is carried out. In general, the drum is repeatedly rotated several times at a designated speed in a regular direction or reverse direction until the laundry is uniformly distributed in the drum, and the rotation of the drum to perform the rinsing cycle is carried out after the uniform distribution of the laundry in the drum is obtained. Therefore, when the intermediate dehydration is carried out after the washing cycle is completed and the water supply for the rinsing cycle is carried out under the condition that the drum is stopped, the operation of the rinsing cycle is substantially reduced. Further, when the operation time of the rinsing cycle is considered from the completion of the above uniform distribution of the laundry, a time delay to complete the course is caused by the time taken to complete the uniform distribution of the laundry. Therefore, the above problem is solved by continuously rotating the drum from dehydration before the rinsing cycle at least to drainage of the rinsing cycle without stoppage.

The above description is in relation to the selection of the course including the plurality of cycles. However, respective cycles may be selected and setting of the cycles may be changed.

For example, a control method of a laundry machine includes receiving at least one cycle selected by a user, receiving a time when the at least one cycle is desired to be completed, or an operation time of the at least one cycle, input by the user, and performing the at least one cycle so as to complete the at least one cycle at the time when the at least one cycle is desired to be completed, or within the operation time.

The above control method is the same as the control method in relation to the course except that the above control method case is applied to respective cycles, and thus a detailed description thereof will be omitted.

A laundry machine in accordance with the present invention is a laundry machine to achieve the above-described control method.

The above laundry machine includes a course/cycle selection unit to receive a course or a cycle selected by a user, a time input unit to receive a time when the course or the cycle is desired to be completed, or an operation time of the course or the cycle, input by the user, and a controller to perform the course or the cycle so as to complete the course or the cycle at the time when the course or the cycle is desired to be completed, or within the operation time.

As described above, the laundry machine may further include a control panel for interface with the user, as described above. The course/cycle selection unit may be provided on the control panel. For example, a course dial is provided as the course selection unit, and buttons for respective cycles are provided as the cycle selection unit. A conventional washing machine includes an option button for a user to select options of cycles of a selected course, in addition to the course dial, and the option button may be used as the cycle selection unit.

Further, a separate input unit to change the controller into a state, in which setting of the course or the cycle is changed, may be provided on the control panel. For example, a button under the name of a shortened course or a setting change is provided on the control panel, and when the button is pushed, the controller is changed to a state, in which change of setting input from the user may be received.

If the button instructing the state change is not pushed, the time input unit may enter an inactive state.

The time input unit may be provided to individually input operation times of respective cycles of the course. That is, times when the respective cycles of the course are desired to be completed, or operation times of the respective cycles of the course may be input through the time input unit.

The controller may control related components so as to adjust an operation time of the selected course or cycle, which is set in advance, if the set operation time of the selected course or cycle exceeds the input time when the course or the cycle is desired to be completed, or the input operation time.

The laundry machine may further include a display unit to display the adjusted time. Here, the adjusted operation time may be displayed according to the respective cycles of the course.

Such a laundry machine achieves the above-described control method, and thus may have components required to achieve the control method. Some of these components are deduced directly from the above description of the control method, and thus a detailed description thereof will be omitted so as to avoid repetition.

### Advantageous Effects

Settings of courses or cycles may be used as they are, and if necessary, the settings may be changed.

For example, since an operation time of a course in a washing machine may be adjusted to a time desired by a consumer, the consumer may adjust the operation time of the course to the desired time while maintaining characteristics of the course, and thus more easily use the washing machine.

In accordance with the present invention, it is possible to basically solve problems of conventional drum-type washing machines and pulsator-type washing machines. More concretely, in accordance with the present invention, there is provided a new-type laundry machine having advantages of both the drum-type washing machine and the pulsator-type washing machine.

In accordance with the present invention, there is provided a laundry machine, which converts a drum-type washing machine into a pulsator-type washing machine or a pulsator-type washing machine into a drum-type washing machine according to user's selection or so as to satisfy optimum conditions.

Further, in accordance with the present invention, there is provided a laundry machine, which exhibits optimum performance by changing a tilting angle of a rotary axis of a drum according to user s selection or if necessary when various washing courses, and sub-courses or options in the washing courses are performed by rotating the drum.

Moreover, in accordance with the present invention, there is provided a laundry machine, which prevents child accidents generated from a drum-type washing machine.

### BRIEF DESCRIPTION OF DRAWINGS

The accompanying drawings, which are included to provide a further understanding of the invention, illustrate embodiments of the invention and together with the description serve to explain the principle of the invention.

In the drawings:

FIG. 1 is a perspective view of a drum-type washing machine in accordance with the present invention;

FIG. 2 is a plan view of a control panel of the washing machine of FIG. 1;

FIG. 3 is a flow chart illustrating a control method of the washing machine;

FIG. 4 is a flow chart illustrating a control method of the washing machine if an operation time is input while a course is in progress;

FIG. 5 is a flow chart illustrating a control method of the washing machine if an operation time of a cycle is input;

FIG. 6 illustrates one example of adjustment of a set operation time of a course; and

FIG. 7 illustrates another example of adjustment of a set operation time of a course.

### BEST MODE FOR CARRYING OUT THE INVENTION

A laundry machine and a control method thereof in accordance with a preferred embodiment of the present invention may be applied to machines, which treat laundry. Although, in this embodiment, the present invention is applied to a washing machine, particularly to a drum-type washing machine, the present invention may be applied to other machines, such as a drying machine using the same method as is applied to the washing machine. The application of the present invention to other laundry machines will be easily deduced directly from the below description of the washing machine.

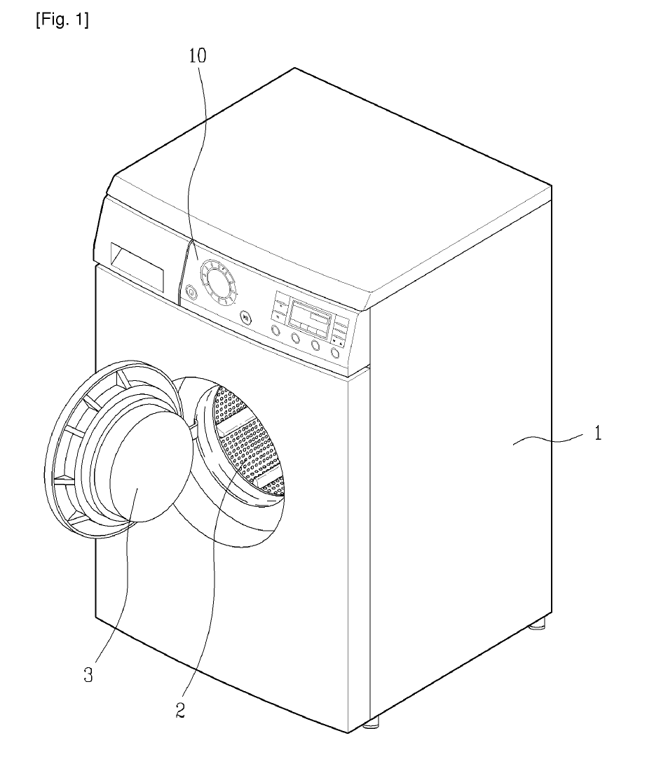

First, FIG. 1 illustrates a drum-type washing machine in accordance with the present invention.

The above washing machine includes a cabinet 1 forming the external appearance of the washing machine, a tub (not shown) provided within the cabinet 1, and a drum 2 rotatably provided at the inside of the tub.

Water is contained within the tub, and laundry to be washed is put into the drum 2 through a front door 3 of the cabinet 1. The drum 2 is rotatable by a driving unit (not shown), such as a motor, and washing, rinsing, and dehydrating courses are carried out by rotating the drum 20.

A control panel 10 may be provided on the front surface of the cabinet 1. The control panel 10 serves to input instructions to the washing machine and display operation data, thereby providing the data to a user.

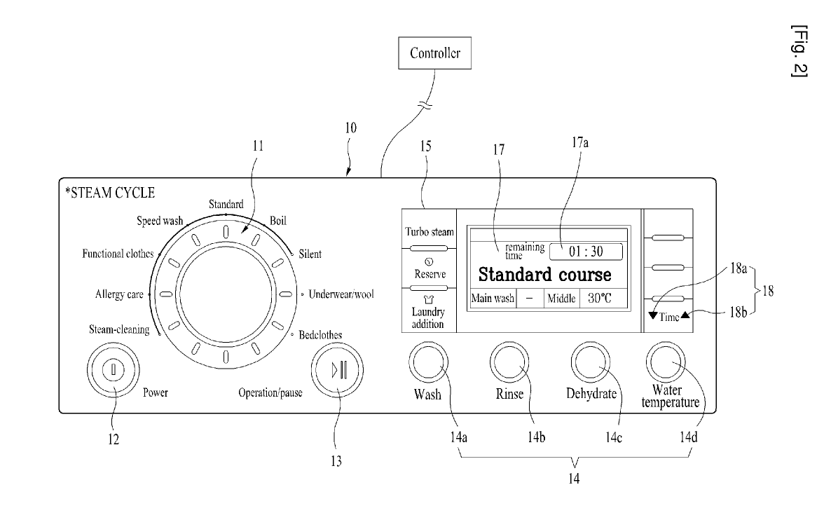

As shown in FIG. 2, the control panel 10 includes a course dial 11, serving as a course selection unit, and an option selection unit 14.

Further, a display window 17 to display data regarding washing courses to the user is provided, and a steam selection unit 15 to select use of steam, a power button 12, and an operation/pause button 13 are provided.

The course dial 11 is used to select one of various washing courses, and the user selects a desired washing course by turning the course dial 11.

The option selection unit 14 is used to select one of detailed conditions of the respective washing courses, such as, washing, rinsing, dehydrating, and water temperature.

A washing option selection unit 14a is used to select one of kinds of a washing cycle, such as main washing, rough washing, soaking, no washing, and baby clothes.

A water temperature option selection unit 14d is used to select a water temperature, such as cold water, 30 degrees, or 40 degrees.

The rinsing option selection unit 14b is used to select the number of times of rinsing, such as no rinsing, once, twice, or three times. A series of processes of performing rinsing by supplying water and rotating the drum and performing dehydrating is defined as once in the number of times of rinsing.

The dehydrating option selection unit 14c is used to select a degree of dehydrating, relating to a dehydrating cycle, such as no dehydrating, subtle, weak, middle, strong, or strongest. Here, the degree of dehydrating relates to a rotating speed of the drum during dehydrating.

A user selects a desired course through the course dial 11 and the option selection unit 14. That is, the user may select the desired course through the course dial 11, and may additionally select detailed conditions of the respective cycles of the selected course through the option selection unit 14. Concretely, when the user selects a course through the course dial 11, setting of the respective cycles, set as defaults in the selected course, is processed to be selected, and then the user selects additional factors of the respective cycles through the option selection unit 14.

When the user selects the operation button 13 after the selection of the course using the course dial 11 and the option selection unit 13, as described above, the course is performed as it is set.

Here, when the user pushes a time button 18, serving as a time input unit, a time for the selected course is input. FIG. 2 illustrates that an operation time of the selected course is 1 hour 30 minutes (remaining time in FIG. 2), and such an operation time is an operation time set in advance for a standard course.

The user may input an operation time of 1 hour using the time button 18. The operation time may be input using a time increment button part 18a and a time decrement button part 18b. In this case, it is necessary to decrease the time to 1 hour, and thus the time decrement button part 18b is used.

Further, the above change of the set time may be individually achieved in the respective cycles. When the washing option selection unit 14a is pushed, wash is displayed on the display window 17 in place of standard course, and the operation time of washing is displayed on a time display unit 17a. Here, the user may input the time of washing using the time button 18.

In the same manner, the user may input the time for the rinsing cycle and dehydrating cycle.

When the time button 18 is pushed lengthily after the input of the times of the respective cycles is completed or a designated time after the input of the times is completed elapses, standard course is displayed again on the display window 17, and the time display unit 17a displays the total sum of the above input times of the respective cycles as the operation time.

Differing from the individual input of the times of the respective cycles, as described above, the control panel 10 may be configured such that the user selects a preferred cycle after the input of the operation time of the course. Further, the control panel 10 may be configured such that when the cycle is selected, the operation time of the selected cycle is not adjusted or is adjusted at a lower rate than those of other cycles. For example, when the user inputs the operation time of a course, the display window 17 displays a question of Which cycle is preferred?, and when the user selects one cycle by pushing any one of the washing option selection unit 14a, the rinsing option selection unit 14b, and the dehydrating option selection unit 14c of the option selection unit 14, the operation time of the selected cycle is not adjusted or is adjusted at a lower rate than those of other cycles.

When the user pushes the operation button 13 after the input of the time for the course is completed, a controller adjusts the set operation time of the selected course to the input operation time.

Further, the controller performs the course for the adjusted operation time, and thus controls the washing machine such that the course is completed at the time input by the user.

Here, the time button 18 also serves as a state change input unit to change the set operation time of the course. However, differing from the above description, a separate input unit (not shown) to input state change may be provided. For example, a set time change button may be additionally provided on the control panel 10. When the set time change button is pushed, the control panel 10 is changed to a state, in which a time is input so as to change the operation time of the course selected by the course selection unit. That is, when the set time change button is pushed, the controller receives the time input from the time button 18 and adjusts the operation time of the selected course based on the input time.

The above set time change button may be provided integrally with the time button 18. For example, the time button 18 may be configured such that when the time button 18 is pushed twice within 1 second or the pushed state of the time button 18 is maintained for a designated time, the controller acts as if the controller receives the state change input using the above set time change button.

The time button 18 may be used before the course is performed, or may be used while the course is in progress. When the time button 18 is used before the course is performed, the operation time of the course is input and the course is performed for the adjusted operation time, as described above.

Hereinafter, use of the time button 18 while the course is in progress will be described. While the course is in progress, the time displayed on the time display unit 17a of the display window 17 is the remaining operation time of the course. In this case, when a time is input by the time button 18, the remaining operation time is adjusted to the input time.

That is, in case that the remaining operation time of the standard course, which is in progress, is 1 hour, a user may reduce the remaining operation time to 30 minutes using the time button 18. Then, the controller adjusts the remaining operation time of the standard course to 30 minutes input by the user.

While the course is in progress, the pause button 13 is pushed so as to stop the operation of the washing machine and then achieve the above time input. Then, when the operation button 13 is pushed after the time input is completed, the controller adjusts the operation time of the course so as to complete the remaining operation of the course within the input time.

Although the above explanation describes that the operation time is input by the time button 18, a time when a course or a cycle is desired to be completed may be input. That is, a user does not input the operation time of a desired course, but may input a time when the course is desired to be completed.

Next, a control method of the washing machine will be described.

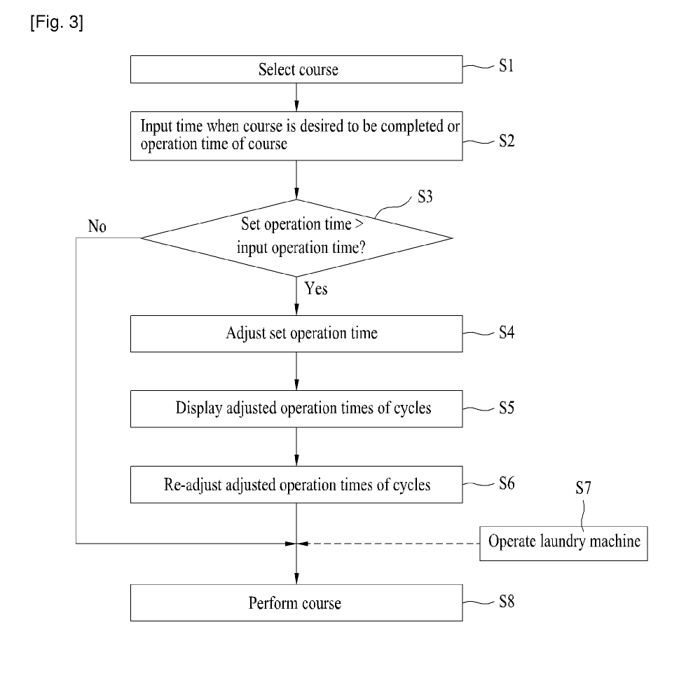

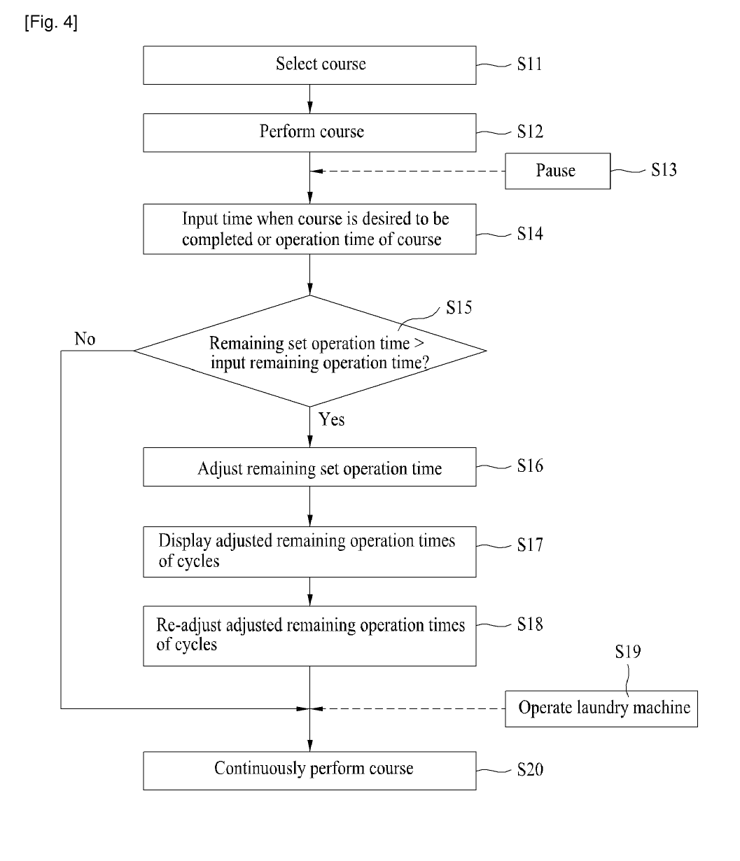

FIG. 3 illustrates a control method of the washing machine before a course is preformed, and FIG. 4 illustrates a control method of the washing machine while a course is in progress.

First, the control method of the washing machine of FIG. 3 will be described.

A user selects a desired course through the course dial 11 and the option selection unit 14 (S1). When the course is selected, the name of the selected course and the set operation time of the selected course are displayed on the display window 17. For example, as shown in FIG. 2, a standard course is displayed on the display window 17, and the set operation time 1 hour 30 minutes is displayed as the remaining time on the time display unit 17a.

After the selection of the course, the user inputs an operation time of the selected course using the time button 18 (S2). For example, the user inputs 1 hour as the operation time so as to change the set operation time of 1 hour 30 minutes of the selected standard course.

When the selection of the course and the input of the time are carried out, the controller compares the set operation time of the selected course with the input operation time (S3). Here, if the set operation time is longer than the input operation time, the set operation time is adjusted to the input operation time (S4). The above time adjustment will be described later.

On the other hand, if the set operation time is not longer than the input operation time, the selected course is performed for the set operation time in this embodiment.

When the time adjustment is completed, operation times of respective cycles of the selected course are displayed on the display window 17 so as to allow the user to check the times of the respective cycles (S5). Here, if necessary, the user may re-adjust the times of the respective cycles using the time button 18 (S6).

The time re-adjustment according to the cycles is achieved using the option selection unit 14 and the time button 18. For example, if the user wishes to re-adjust the operation time of the wishing cycle, the user pushes the washing option selection unit 14a and then re-adjusts the operation time of the wishing cycle using the time button 18.

After the input of the operation time of the course using the time button 18 is completed and the adjustment of the set operation time of the course thereby is completed, when the user pushes the operation button 13 (S7), the course is performed (S8).

Next, the control method of washing machine of FIG. 4 will be described.

In this case, a user selects a desired course (S11), and time input is carried out using the time button 18 while the course is in progress by pushing the operation button 13 (S12).

While the course is in progress, a time displayed on the display window 17 is the remaining operation time of the course. Further, a time, which is to be input and to be adjusted, means the remaining operation time. Here, the remaining operation time is the remainder of the set operation time of the course, i.e., the set operation time which will pass from now on.

While the course is in progress, the user inputs a time by pushing the time button 18 (S14). Before the time input, the user may pause the operation of the washing machine by pushing the pause button 13 (S13).

When the time is input through the time button 18, the controller compares the remaining operation time of the selected course with the input time (S15).

Here, if the remaining set operation time is longer than the input operation time, the remaining set operation time is adjusted to the input operation time (S16). That, the remaining set operation time of the source is adjusted.

On the other hand, if the remaining set operation time is not longer than the input operation time, the selected course is performed for the remaining set operation time.

When the time adjustment is completed, operation times of respective cycles of the selected course are displayed on the display window 17 so as to allow the user to check the operation times of the respective cycles (S17). Here, if necessary, the user may re-adjust the operation times of the respective cycles using the time button 18 (S18).

The time re-adjustment according to the cycles is achieved also using the option selection unit 14 and the time button 18.

After the input of the operation time of the course using the time button 18 is completed and the adjustment of the set operation time of the course thereby is completed, when the user pushes the operation button 13 (S19), the course is continuously performed for the adjusted time (S20).

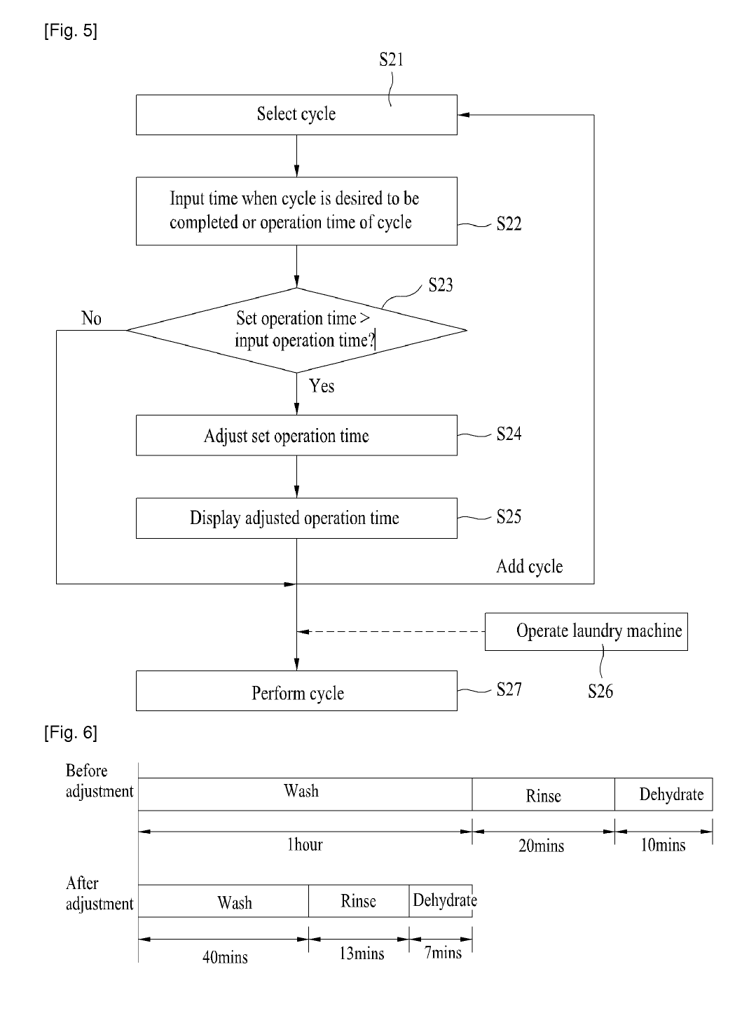

FIG. 5 illustrates a control method of the washing machine if cycles are individually selected and operation times of cycles are adjusted.

The control method of FIG. 5 differs from those of FIGS. 3 and 4 in that the control method of FIG. 5 is applied to cycles rather than courses.

First, a user selects a desired cycle through the control panel 10 (S21). The selection of cycle is achieved using the option selection unit 14 in the control panel 10, as shown in FIG. 2. For example, in case that the user selects the washing cycle, the user pushes the washing option selection unit 14a for more than a designated time. Here, the course selected on the course dial 11 is released from the selection, and the desired cycle is selected through the option selection unit 14.

When the cycle is selected, the name of the selected cycle and the set operation time of the selected cycle are displayed on the display window 17.

Thereafter, the user inputs a time when the cycle is desired to be completed or an operation of the cycle using the time button 18 (S22).

When the time is input, the controller compares the set operation time of the selected cycle with the input time (S23).

If the set operation time is longer than the input time, the set operation time is adjusted to the input time (S24). That is, the set operation time of the cycle is adjusted.

On the other hand, if the set operation time is not longer than the input time, the selected cycle is performed for the set operation time.

When the time adjustment is completed, the adjusted time is displayed on the display window 17 (S25).

After the input of the operation time of the cycle using the time button 18 is completed and the adjustment of the set operation time of the cycle thereby is completed, when the user pushes the operation button 13 (S27), the cycle is performed for the adjusted time (S27).

In case that the user wishes to adjust operation times of other cycles, a process from S21 to S25 is repeated. Thereafter, when the user finally pushes the operation button 13 (S26), the selected cycles are successively performed.

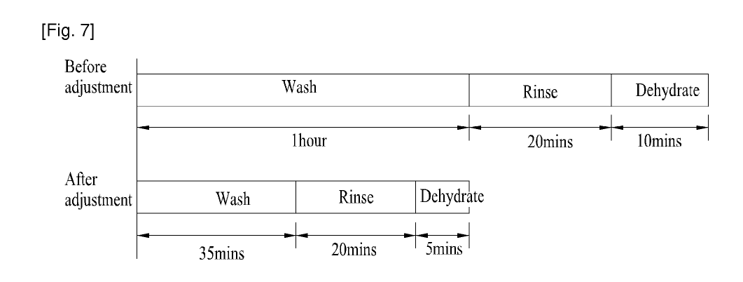

Hereinafter, adjustment of a set operation time of a course will be described with reference to FIGS. 6 and 7.

The adjustment of the set operation time to a time input by a user may be achieved by various methods.

FIG. 6 illustrates a method of adjusting a set operation time of a course, in which operation times of respective cycles are adjusted at the same time rate.

First, a set operation time of a selected course before adjustment is a total of 1 hour 30 minutes, which is the sum of 1 hour for a set operation time of the washing cycle, 20 minutes for a set operation time of the rinsing cycle, and 10 minutes for a set operation time of the dehydrating cycle.

Here, if the user inputs 1 hour as the total operation time of the course, the operation times of the respective cycles are adjusted at the same time rate. That is, since the total operation time of the course is reduced from 1 hour 30 minutes to 1 hour by 33.3%, the operation times of the respective cycles of the course are adjusted by 33.3%. Therefore, the operation time of the washing cycle is adjusted to 40 minutes, the operation time of the rinsing cycle is adjusted to 13 minutes, and the operation time of the dehydrating cycle is adjusted to 7 minutes.

At this time, the precise values of the adjusted operation times of the rinsing cycle and the dehydrating cycle are 13.333 minutes and 6.666 minutes, but the values are rounded off at the nearest decimal. Although the operation times of the respective cycles are adjusted by any method, such a difference may be allowed.

FIG. 6 illustrates another method of adjusting a set operation time of a course. In this method, a set operation time of the rinsing cycle is not adjusted but only set operation times of the washing cycle and the dehydrating cycle are adjusted. Although the course is performed for a reduced operation time, the amount of detergent used may be equal. Therefore, in order to completely remove the detergent, it is necessary to maintain the operation time of the rinsing cycle.

The rinsing cycle may be performed by continuously rotating the drum, which is rotated to perform intermediate dehydration after the washing cycle is completed, without stoppage. Here, the rotating speed of the drum in the rinsing cycle may be reduced compared with that of the drum during the intermediate dehydration.

Concretely, when the washing cycle is completed, drainage is carried out, intermediate dehydration is carried out by rotating the drum at a high speed so as to remove moisture from laundry, and then drainage is carried out again so as to drain the removed moisture. Thereafter, new water is supplied to the drum, and then the rinsing cycle is performed.

Here, the drum is rotated at a first rotating speed, for example, 600 rpm, during the intermediate dehydration, and is rotated at a second rotating speed enough to prevent the laundry from being separated from the wall of the drum, for example, 100˜110 rpm, during the drainage to discharge water removed from the laundry in the intermediate dehydration and the water supply to perform the rinsing cycle.

After the water supply to perform the rinsing cycle is completed, the drum is rotated at a third rotating speed, and thus the rinsing of the laundry is carried out.

### Mode for the Invention

Various embodiments have been described in the best mode for carrying out the invention.

### INDUSTRIAL APPLICABILITY

As is apparent from the above description, in accordance with the present invention, settings of courses or cycles may be used as they are, and if necessary, the settings may be changed.

For example, since an operation time of a course in a washing machine may be adjusted to a time desired by a consumer, the consumer may adjust the operation time of the course to the desired time while maintaining characteristics of the course, and thus more easily use the washing machine.

In accordance with the present invention, it is possible to basically solve problems of conventional drum-type washing machines and pulsator-type washing machines.

More concretely, in accordance with the present invention, there is provided a new-type laundry machine having advantages of both the drum-type washing machine and the pulsator-type washing machine.

In accordance with the present invention, there is provided a laundry machine, which converts a drum-type washing machine into a pulsator-type washing machine or a pulsator-type washing machine into a drum-type washing machine according to users selection or so as to satisfy optimum conditions.

Further, in accordance with the present invention, there is provided a laundry machine, which exhibits optimum performance by changing a tilting angle of a rotary axis of a drum according to user's selection or if necessary when various washing courses, and sub-courses or options in the washing courses are performed by rotating the drum.

Moreover, in accordance with the present invention, there is provided a laundry machine, which prevents child accidents generated from a drum-type washing machine.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A control method of a laundry machine comprising:
receiving an operation, which is to be performed for treating laundry, input by a user;
receiving a time, which is required to complete the operation from a start time or re-start time of the operation, input by the user; and
performing the operation according to the input time.

2. The control method according to claim 1, wherein the performance of the operation includes adjusting an operation time of the input operation, which is set in advance, if the set operation time of the input operation exceeds the input time.

3. The control method according to claim 2, wherein, in the adjustment of the operation time, operation times of respective cycles forming the input operation, which are set in advance, are adjusted.

4. The control method according to claim 3, wherein, in the adjustment of the operation time, the set operation times of respective cycles are adjusted according to a time rate.

5. The control method according to claim 2, wherein, in the adjustment of the operation time, an operation time of only a specific cycle among cycles forming the input operation, which is set in advance, is adjusted, or the operation time of the specific cycle is adjusted at a lower rate than those of other cycles.

6. The control method according to claim 5, further comprising receiving the specific cycle input by the user.

7. The control method according to claim 1, further comprising displaying operation times of respective cycles forming the input operation.

8. The control method according to claim 7, wherein the performance of the operation includes adjusting an operation time of the input operation, which is set in advance, if the set operation time of the input operation exceeds the input time.

9. The control method according to claim 8, wherein, in the display of the operation times, the operation times of the respective cycles are displayed corresponding to the operation time adjusted in the adjustment of the operation time.

10. The control method according to claim 8, further comprising re-adjusting the displayed operation times of the cycles by the user.

11. The control method according to claim 1, wherein the input of the operation is achieved through a course selection unit and/or an option selection unit.

12. The control method according to claim 11, wherein the operation input through the course selection unit is changeable through the option selection unit.

13. The control method according to claim 11, wherein the course selection unit is provided to input a course operation formed by combining a plurality of cycles, and the option selection unit is provided to input an operation combined with the course operation or independently including at least one cycle.

14. The control method according to claim 1, wherein the reception of the input time includes receiving operation times of respective cycles, forming the input operation, input by the user.

15. The control method according to claim 1, wherein if an operation including a washing cycle and a rinsing cycle is input, a drum is continuously rotated from intermediate dehydration after completion of the washing cycle to drainage after rinsing of the rinsing cycle during the performance of the operation.

16. A laundry machine comprising:
a cabinet;
a drum, in which laundry is contained;
an operation selection unit provided for a user to select an operation, which is to be performed;
a time input unit provided for the user to input an operation time, which is required to complete the operation from a start time or re-start time of the operation inputted through the operation selection unit; and
a controller to control the performance of the operation by driving the drum according to the input operation time.

17. The laundry machine according to claim 16, wherein the controller adjusts an operation time of the input operation, which is set in advance, if the set operation time of the input operation exceeds the input operation time.

18. The laundry machine according to claim 17, wherein the operation selection unit includes a course selection unit provided to select a course operated by combination of cycles, and/or an option selection unit provided to select an option combined with the course or independently operated by at least one cycle.

19. The laundry machine according to claim 18, wherein the time input unit is provided to individually input operation times of the respective cycles.

20. The laundry machine according to claim 17, further comprising a display unit to display the adjusted operation time or adjusted operation times of respective cycles.
